(19) United States
(12) Patent Application Publication
(10) Pub. No.: US 2006/0006640 A1
(43) Pub. Date: Jan. 12, 2006

(54) Pipe coupling device

(75) Inventor: Patrick C. Knight, Raceland, LA (US)

Correspondence Address: NIXON PEABODY, LLP, 401 9TH STREET, NW, SUITE 900, WASHINGTON, DC, 20004-2128, US

(73) Assignee: Benoit Machine L.L.C., Houma, LA (US)

(21) Appl. No.: 10/888,003

(22) Filed: Jul. 12, 2004

(51) Int. Cl. F16L 35/00

(52) U.S. Cl. 285/81

(57) ABSTRACT

A pipe coupling assembly and method for protecting control lines is disclosed wherein a shoulder modification is made on the pipes to prevent breakage of a control line protector clamp. Particularly, the present invention relates to a coupling assembly for protecting a control line comprising a first pipe including a first stop surface, a second pipe longitudinally connected to the first pipe, a clamping device connected to the first pipe and the second pipe, the clamping device including a first clamping end connected to the first pipe and a control line receiving portion, and a control line extending along the length of the first pipe and the second pipe, the control line being positioned within the control line receiving portion of the clamping device. Additionally, the first stop surface is positioned at a predetermined angle relative to the first pipe to prevent breakage of the clamping device.

### BACKGROUND OF THE INVENTION

1. Technical Field

This invention relates generally to control line protector clamps, and more particularly to a modification made to a pipe coupling assembly including a control line protector clamp to prevent breakage of the control line protector clamp.

2. Description of Related Art

In well applications, sections of production tubing are linearly connected to form a production tubing string which is extended downwards into a well bore. The individual sections of production tubing are coupled together until a string of the desired length is formed.

Traditional pipe couplings used in well applications may also be applied to other uses in the art, such as blast joints or underground applications. Examples of patented pipe coupling devices such as those used in well applications are disclosed in U.S. Pat. Nos. 4,613,165, Re. 34,017, 4,635,968, 4,299,413, and 6,123,363.

U.S. Pat. Nos. 4,613,165 issued Sep. 23, 1986 and Re. 34,017 issued Aug. 4, 1992, each issued to Kuhne and entitled “Increased Tensile Strength Variable Diameter Protective Joint”, relate to a protective joint for tubulars, such as oil well production tubing, having a body portion with a first diameter and at least one coupling portion having an increased diameter portion. At least a part of both the first and increased diameter portions are included within a zone to be protected by the protective joint. The protective joint includes a plurality of first and second generally cylindrical annular protective rings, such as carbide rings. The first protective rings are coaxially located along the body portion of the tubular. The second protective rings are coaxially located along the increased diameter portion of an upset. The first and second protective rings have flat and parallel faces and are sized and configured to accommodate bending movements along the longitudinal axis of the tubular. For example, the first and second protective rings may have flattened parallel faces, sufficient inside diameters and be engagable with like protective rings along a plane intersecting and normal to the inside longitudinal axis of the tubular to accommodate bending movements along the longitudinal axis of the tubular.

U.S. Pat. No. 4,635,968 issued to Kuhne on Jan. 13, 1987 entitled “Method and Apparatus for Protecting Consecutive Multiple Variable Diameter Couplings” relates to a method for installing multiple protective joints on tubulars. In particular, the tubulars have a body portion and an increased diameter portion for coupling to another tubular. At least a part of the body and increased diameter portions of each tubular are to be included in a zone to be protected. A plurality of first generally cylindrical annular protective rings are coaxially installed over the body portion of a first tubular. A plurality of second generally cylindrical annular protective rings are also placed coaxially locatable along the increased diameter portion of each tubular and are supported on the body portion with at least one sleeve coaxially located below along the body portion of the first tubular. During transport or storage the first and second protective rings are held in place by retainers. During installation a second tubular is coupled to the first tubular. The second protective rings are then placed over the increased diameter portion of the second tubular while using at least one sleeve to limit movement of the second protective rings in their radial direction and facilitate movement of those rings over the increased diameter portion of the second tubular while using at least one sleeve to limit movement of the second protective rings in the their radial direction and facilitate movement of those rings over the increased diameter and body portions of the coupled tubular. There can thus be provided a series of multiple protective joints for use on consecutive tubulars having increased diameter portions for coupling to another tubular.

U.S. Pat. No. 4,299,413 issued to Neher on Nov. 10, 1981 entitled “Pipe Coupling” relates to a coupling assembly for connecting sections of pipe including a tubular sleeve adapted to receive the ends of the pipe section. The inside surface of the sleeve includes means for providing a pressure-tight seal between the pipe sections and the sleeve. A pair of generally arcuate clamp members is formed for connection to each other to form a clamp assembly. Each clamp member has an internal recess of such dimensions that when the clamp members are connected to each other about the sleeve, only the clamp members absorb the mechanical stresses exerted on the coupling. The clamp members about or surrounding the sleeve are spaced from and out of contact with the sleeve. Additionally, each clamp member can have flanged generally semi-cylindrical end sections, sized to fit about the pipe, and which form a split-ring clamp when the clamp members are fitted together in opposing relationship. The flanges are adapted for receiving fastening means for securing the clamp members together. The inner surface of the end sections includes means for securely gripping the outer surface of the pipe so that when the clamp members are fastened together about the sleeve, they hold the pipe sections together in a securely coupled relationship.

U.S. Pat. No. 6,123,363 issued to Burgard et al. on Sep. 26, 2000 entitled “Self-Centering Low Profile Connection with Trapped Gasket” relates to the assembly of a connection that uses cooperating grooved surfaces to provide an easily disassembled and assembled connection which is improved by the use of a centered lip and cooperating groove on the contact faces of the connection halves that engage the faces of complementary connection ends to prevent lateral misalignment while the pipe ends are brought together for axial alignment. The lip extends into the groove to trap a gasket retained within the groove and inhibit extrusion of the gasket between the contact faces under high pressure conditions. The centering device may be used with a clamping mechanism. The trapping cavity formed by the faces of the connection ends particularly enhances the pressure capacity of elastomeric gasket applications.

After the production tubing string is formed, it is frequently necessary to install mechanically operated devices deep within the well bore. These devices can include such devices as safety valves, chemicals injection mandrels, and pumps. Control line are used to operate these mechanical devices, but the inaccessibility of the devices within the well bore makes the installation and operation of the control lines costly and time consuming. Therefore, the control lines are run down into the well bore along the length of the production tubing string.

Thus, as the production tubing is pushed or pulled through the well bore, the control lines are pushed or pulled through the well bore as well. However, as the production line is longitudinally moved within the well bore, the pipe couplings between the sections of production tubing can collide with or become obstructed by the sides of the well bore as a result of the increased diameter of the production tubing coupling. This increased diameter is typically caused by either a pipe coupling device, such as those described in the references above, or, in the case of tubing, such as integral joint tubing, by a sloping external transition upset leading to the section of the tubing used for the coupling. When these wider sections of the production tubing string impact the sides of the well bore, the control lines may become trapped between the tubing and the sides of the well bore and become damaged or broken.

In an attempt to prevent the breakage of the control lines, control line protector clamps are used. Control line protector clamps are clamps which are clamped around the production tubing at the couplings. Because the control lines may be damaged if crushed or broken, the control lines run through the clamps, for example, via holes or slots formed in the clamps which allow the control lines to move freely. The two ends of the clamps are clamped onto the production tubing on either sides of the pipe coupling, thereby extending over the section of the pipe with the increased diameter, as described above. Thus, when the pipe coupling section of the pipe with the increased diameter would have normally impacted the sides of the well bore, the clamp instead bears the brunt of the impact. Because the control line runs through the clamp, the control line is not impacted by the sides of the well bore and is not damaged or broken.

However, as in the case of integral joint tubing, the pipe coupling may be integrated with the tubing. As described above, the sections of the tubing may include an upset sloping from the tubing body to an pipe coupling section which has an increased diameter. When a control line protector clamp is attached to tubing with a sloping upset, the clamp extends across this sloping upset. During operation, the tubing string will likely encounter a severe obstruction on the wall of the well bore while being moved within the well bore, the clamp may become caught on the obstruction. As the tubing string continues to move, the clamp will slide along the length of the tubing until it encounters the base of the upset. If the resistance caused by the obstruction is sever enough, the clamp may be forced to move along the upset, which thereby causes a wedgelike effect on the clamp. As the clamp travels further along this upset, the wedgelike forces acting on the clamp can break the clamp body, including the means of securing the clamp, such as clamp bolts, etc. If the clamp breaks, the clamp and its components can become disengaged from the pipe coupling. If this occurs, the clamp will fall away from the production tubing string, leaving the control line unprotected. The broken clamp can be very costly and time consuming to retrieve. If the broken clamp is impossible or impractical to replace, the entire clamp will need to be replaced. Also, when the clamp breaks, it is frequently necessary to stop the operation so the broken clamp can be retrieved, repaired, or replaced.

Thus, there is a need for a device or method that prevents breakage of the control line protector clamps used to protect control lines that are positioned next to production tubing strings. This invention answers that need.

### SUMMARY OF THE INVENTION

The present invention provides a pipe coupling assembly for protecting control lines and a method of assembling a pipe coupling assembly for protecting control lines wherein a shoulder modification on the pipes is utilized to prevent axial movement of a clamp, thereby preventing clamp breakage.

In particular, one embodiment of the present invention relates to a pipe coupling assembly for protecting control lines and a method of assembling a pipe coupling assembly for protecting control lines, the assembly and method comprising a first pipe including a first stop surface, a second pipe longitudinally connected to the first pipe, a clamping device connected to the first pipe and the second pipe, the clamping device including a first clamping end connected to the first pipe, the clamping device further including a control line receiving portion, and a control line extending along the length of the first pipe and the second pipe positioned adjacent to the first pipe and the second pipe, the control line being positioned within the control line receiving portion of the clamping device, wherein the first stop surface is positioned on the first pipe at a predetermined angle relative to a longitudinal axis of the first pipe to sufficiently minimize radial force acting against the first clamping end to prevent breakage of the clamping device when an axial force tending to move the clamping device towards the second pipe is applied. The second pipe may also comprise a second stop surface, and the clamping device may include a second clamping end connected to the second pipe, wherein the second stop surface is positioned on the second pipe at a predetermined angle relative to the longitudinal axis of the second pipe to sufficiently minimize radial force acting against the second clamping end to prevent breakage of the clamping device when an axial force tending to move the second clamping device towards the first pipe is applied.

A second embodiment of the present invention relates to a pipe coupling assembly for protecting control lines and a method of assembling a pipe coupling assembly for protecting control lines, the assembly and method comprising a first pipe including a first stop surface, a second pipe longitudinally connected to the first pipe, and a clamping device connected to the first pipe and the second pipe, the clamping device including a first clamping end connected to the first pipe, the clamping device further including a control line receiving portion; and a control line extending along the length of the first pipe and the second pipe positioned adjacent to the first pipe and the second pipe, the control line being positioned within the control line receiving portion of the clamping device, wherein the first stop surface is positioned on the first pipe at a predetermined angle relative to the longitudinal axis of the first pipe to prevent the first clamping end from moving along the first stop surface in an overlapping manner when an axial force tending to move the clamping device towards the second pipe is applied. The second pipe may also comprise a second stop surface, and the clamping device may include a second clamping end connected to the second pipe, wherein the second stop surface is positioned on the second pipe at a predetermined angle relative to the longitudinal axis of the second pipe to prevent the second clamping end from moving along the second stop surface in an overlapping manner when an axial force tending to move the clamping device towards the first pipe is applied.

A third embodiment of the present invention relates to a pipe coupling assembly for protecting control lines and a method of assembling a pipe coupling assembly for protecting control lines, the assembly and method comprising a first pipe including a first stop surface, a second pipe longitudinally connected to the first pipe, and a clamping device connected to the first pipe and the second pipe, the clamping device including a first clamping end connected to the first pipe, the clamping device further including a control line receiving portion; and a control line extending along the length of the first pipe and the second pipe positioned adjacent to the first pipe and the second pipe, the control line being positioned within the control line receiving portion of the clamping device, wherein the first stop surface is positioned on the first pipe at a predetermined angle relative to the longitudinal axis of the first pipe to prevent further movement of the first clamping end along the longitudinal axis toward the first stop surface after the first clamping end comes into contact with the first stop surface. The second pipe may also comprise a second stop surface, and the clamping device may include a second clamping end connected to the second pipe, wherein the second stop surface is positioned on the second pipe at a predetermined angle relative to the longitudinal axis of the second pipe to prevent further movement of the second clamping end along the longitudinal axis toward the second stop surface after the second clamping end comes into contact with the second stop surface.

Each of the above and other embodiments of the present invention may include one or more variations wherein the angle of the first stop surface relative to a longitudinal axis of the first pipe is between 60 degrees and 90 degrees, the angle of the first stop surface relative to a longitudinal axis of the first pipe is 90 degrees, the angle of the first stop surface relative to a longitudinal axis of the first pipe is greater than 90 degrees, the first clamping end includes a substantially transverse clamp stop surface facing the first stop surface, the first stop surface extends circumferentially around the first pipe, and/or the first pipe and the second pipe are of the integral joint tubing type.

These and other features, objects and advantages of the present invention will be in part apparent to those skilled in art and in part pointed out hereinafter.

### BRIEF DESCRIPTION OF THE DRAWINGS

FIG. 1 is a side view of a pipe coupling assembly for protecting control lines of the present invention.

FIG. 2 is a side view of a prior art pipe connection.

FIG. 3 is a cross-sectional view of a prior art pipe connection.

FIG. 4 is a side view of a prior art pipe coupling assembly.

FIG. 5 is a side view of a prior art pipe coupling assembly.

FIG. 6 is a side view of a pipe coupling assembly for protecting control lines of the present invention.

FIG. 7 is a side view of a pipe connection of the present invention.

FIG. 8 is a cross-sectional view of a pipe connection of the present invention.

FIG. 9 is a magnified side view of a portion of a pipe coupling assembly for protecting control lines according to one embodiment of the present invention.

FIG. 10 is a magnified side view of a portion of a pipe coupling assembly for protecting control lines according to another embodiment of the present invention.

FIG. 11 is a magnified side view of a portion of a pipe coupling assembly for protecting control lines according to a third embodiment of the present invention.

### DETAILED DESCRIPTION OF THE PREFERRED EMBODIMENT

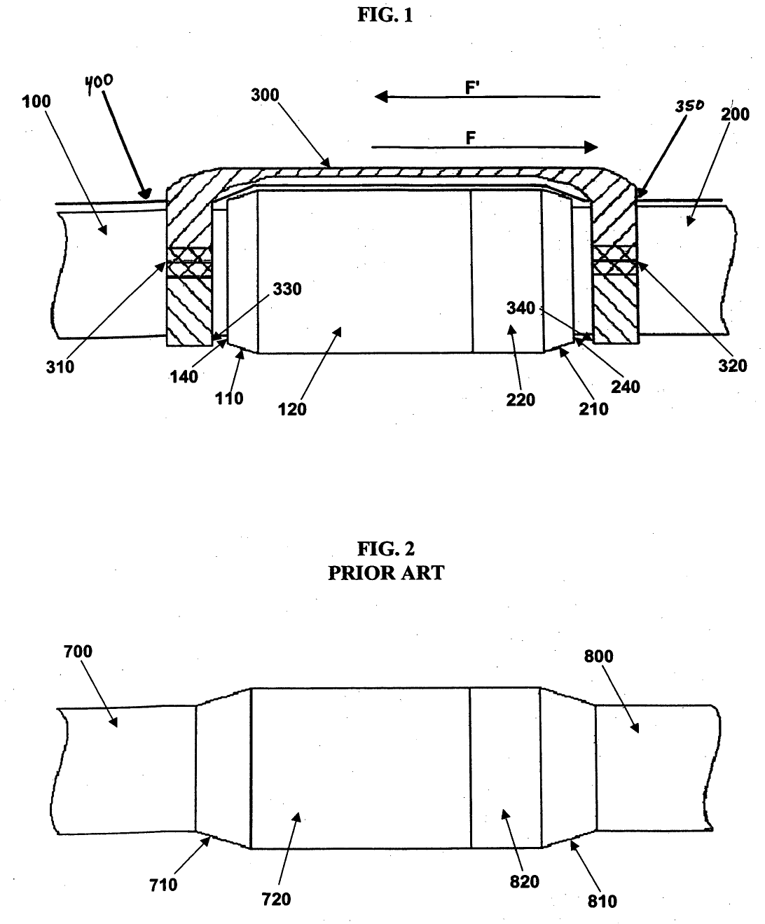

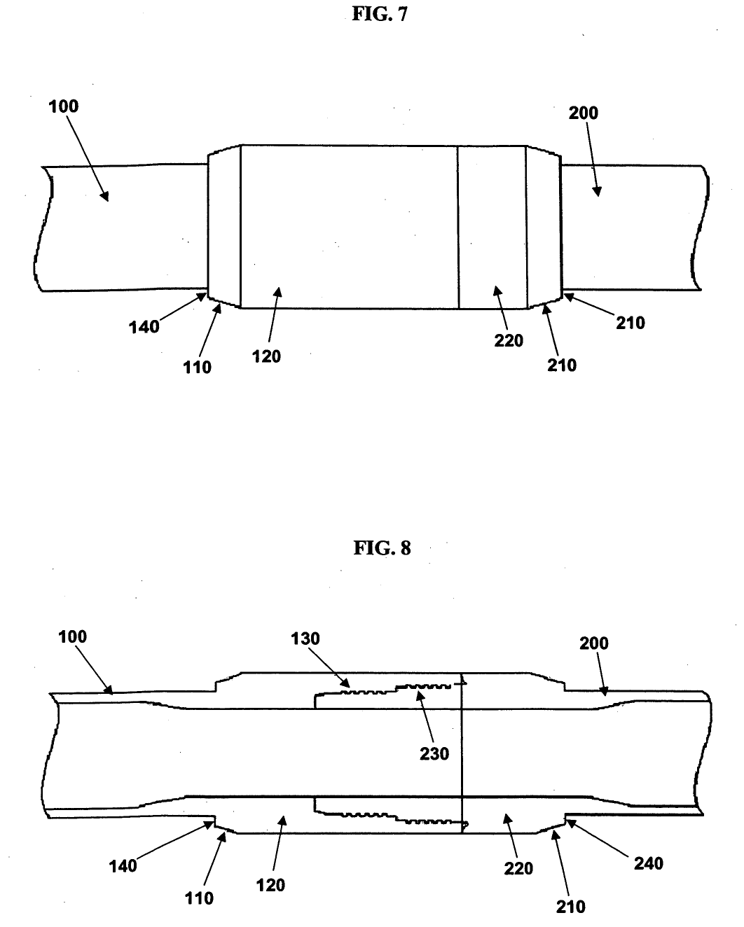

As shown in FIG. 1, a pipe coupling assembly for protecting control lines of the present invention comprises a first pipe 100 longitudinally connected to a second pipe 200, with a clamping device 300 connected to at least one of first pipe 100 and second pipe 200. According to the preferred embodiment, first pipe 100 and second pipe 200 are integral joint tubing pipes. However, the present invention may be applied to any type of piping. First pipe 100 includes a first stop surface 140, a sloping section 110, and a connecting section 120. Second pipe 200 includes a second stop surface 240, a sloping section 210, and a connecting section 220. Any type of longitudinal connection may be utilized to facilitate the connection between first pipe 100 and second pipe 200, such as the threaded connection between internal threaded portion 130 on the first fitting 100 and external threaded portion 230 on second fitting 200 in FIG. 8.

Control line 400 extends along the length of first pipe 100 and second pipe 200 and is preferably positioned adjacent to first pipe 100 and second pipe 200. Control line 400 may be any type of control line, for example, hydraulic lines, signal lines, such as coaxial cable, or electrical lines. As is shown in the figures, because control line 400 extends across the coupling of first pipe 100 and second pipe 200, control line 400 is also adjacent to stop surfaces 140 and 240, sloping sections 110 and 210, and connecting sections 120 and 220.

Clamping device 300 extends across the connection between first pipe 100 and second pipe 200 in a generally overlapping manner and clamps to at least one of first pipe 100 via first clamping end 310 and second pipe 200 via second clamping end 320. Clamping device 300 further includes a control line receiving portion 350 which is sized appropriately to be able to receive control line 400. Control line receiving portion 350 may be of any type, such as a machined hole or slit, but is preferably a slit in which control line 400 is placed. Additionally, there may be a control line receiving portion 350 in either or both of first clamping end 310 and second clamping end 320, or control line receiving portion 350 may extend the entire length of clamping device 300, thus allowing control line 400 to pass through the main portion of the body of clamping device 300. Note that clamping device 300 is not required to include both first clamping end 310 and second clamping end 320. For some applications, clamping device 300 may be permanently affixed to second pipe 200 in a manner such that only one clamping end is used, such as first clamping end 310 on first pipe 100. In this instance, after first pipe 100 and second pipe 200 are longitudinally connected, first clamping end 310 is clamped around first pipe 100 to protect control line 400.

Referring now to prior art FIGS. 2-5, which show a typical conventional pipe connection, connecting section 720 of first pipe 700 has a greater diameter than first pipe 700. Also, connecting section 820 of second pipe 800 has a greater diameter than second pipe 800. Sloping section 710 gradually slopes from the outer surface of first pipe 700 to the outer surface of connecting section 720. Similarly, sloping section 810 gradually slopes from the outer surface of first pipe 800 to the outer surface of connecting section 820. Note that neither first pipe 700 or second pipe 800 includes a stop surface such as first stop surface 140 on first pipe 100 or second stop surface 240 of second pipe 200 in FIG. 1. As shown in FIG. 3, first pipe 700 and second pipe 800 are typically threaded longitudinally together via internal threaded portion 730 of first pipe 700 and external threaded portion 830 of second pipe 800.

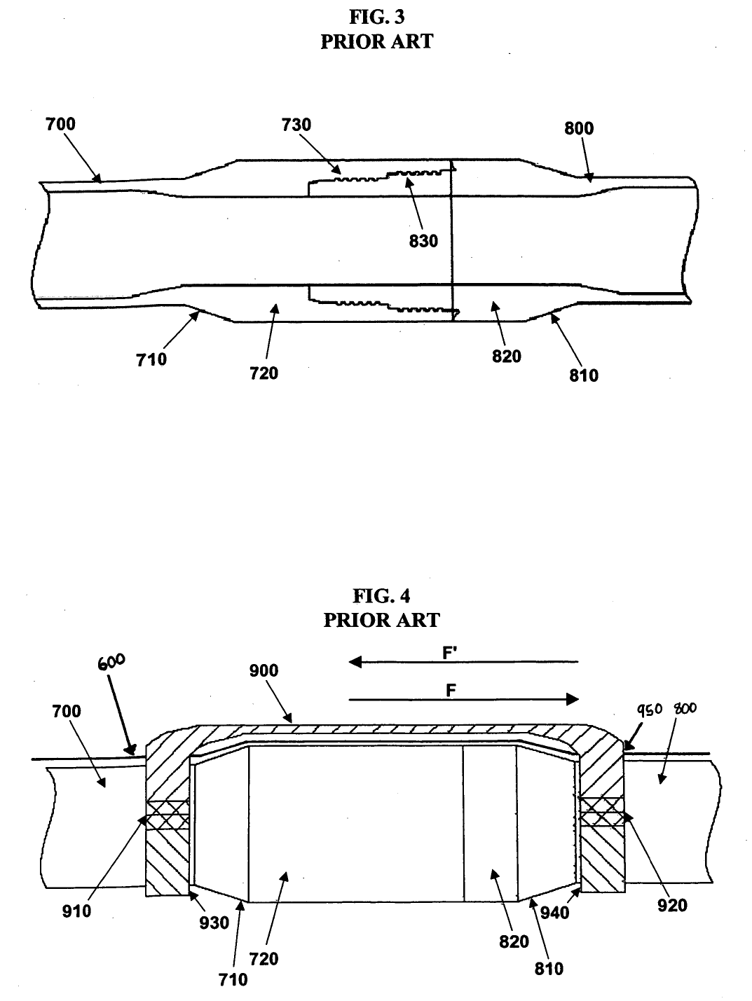

Now referring to FIG. 4, clamping device 900 is connected to a prior art pipe coupling between first pipe 700 and second pipe 800 with control line 600 passing through control line receiving portion 950. During operation, axial and/or longitudinal force F may be applied to clamping device 900 in a longitudinal manner, thus forcing clamping device 900 to move along both first pipe 700 and second pipe 800 towards second pipe 800. If force F is of a sufficient magnitude, clamping device 900 slides along first pipe 700 towards sloping section 710. Thus, if force F is maintained for a sufficient duration of time, first clamping end 910 of clamping device 900 will eventually come into contact with the base of sloping section 710, as shown in FIG. 5. When this occurs, first clamp stop surface 930 on first clamping end 910 comes into contact with the base of sloping section 710. If force F continues to force clamping device 900 along first pipe 700 and second pipe 800, first clamping end 910 will move up sloping surface 710, thereby allowing sloping surface 710 to have a wedge-like effect on first clamping end 910. This wedge-like effect of sloping surface 710 on first clamping end 910 exerts a force F_{T} against first clamping end 910 which includes a radially outward force component F_{R}.

If F_{T}, and specifically F_{R}, increases to an excessive level, such force may cause first clamping end 910 to structurally weaken, fracture, or even completely break. If first clamping end 910 breaks, clamping device 900 may disengage from first pipe 700, thereby possibly exposing control line 600 to damage or breakage. This problem can also occur in the opposite direction if a force F′ is applied, thereby forcing second clamp stop surface 940 to contact sloping section 810 and eventually causing second clamping end 920 to structurally weaken, fracture, or break.

As shown in FIGS. 1 and 6-8, the present invention minimizes the chance of either first clamping end 310 or second clamping end 320 weakening, fracturing, or breaking as a result of longitudinal forces F or F′, specifically, as a result of the radial components of those forces acting against clamping device 300 and forcing either first clamping end 310 onto sloping section 110 or second clamping end 320 onto sloping section 220.

According to the present invention, first pipe 100 further includes first stop surface 140. First stop surface 140 is formed into the base section of sloping surface 110 to minimize the chance that first clamping end 310 will break during operation. The specific characteristics of first stop surface 140 will be described in more detail below.

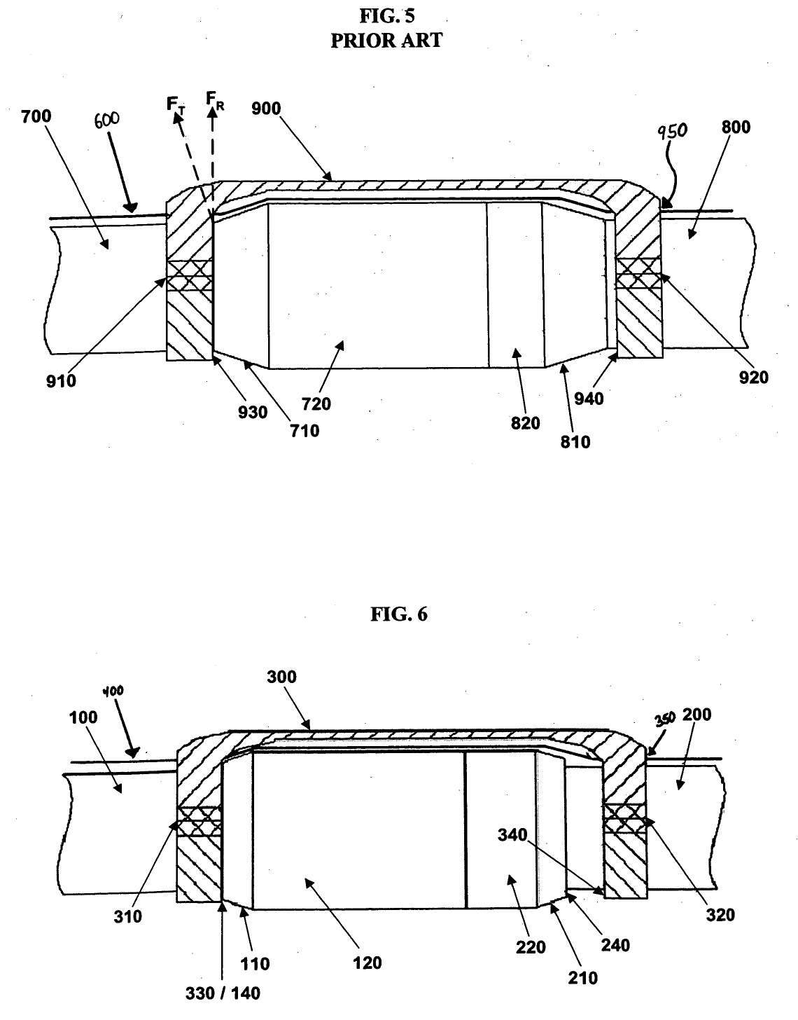

Thus, according to the preferred embodiment as shown in FIG. 1, clamping device 300 is attached to both first pipe 100 and second pipe 200 via first clamping end 310 and second clamping end 320. When a force F is applied to clamping device 300 and is of a sufficient magnitude to cause clamping device 300 to move relative to first pipe 100, clamping device 300 slides along first pipe 100 and second pipe 200. As shown in FIG. 6, if force F is maintained, first clamping end 310 of clamping device 300 will slide along first pipe 100 until it comes into contact with first stop surface 140. When first clamp stop surface 330 of first clamping end 310 comes into contact with first stop surface 140, first clamping end 310 of clamping device 300 is largely prevented from moving any further along the surface of first pipe 100. This effect is possible by forming first stop surface 140 at any angle sufficient to sufficiently minimize or eliminate the above-described wedge-like effect capable of structurally damaging, fracturing, or breaking first clamping end 310 and causing clamping device 300 to possibly disengage from first pipe 100. Also, first stop surface 140 preferably extends circumferentially around first pipe 100. However, first stop surface 140 may be formed in a different manner, such as a plurality of radial portions, or any other design sufficient to achieve the above-described functionality.

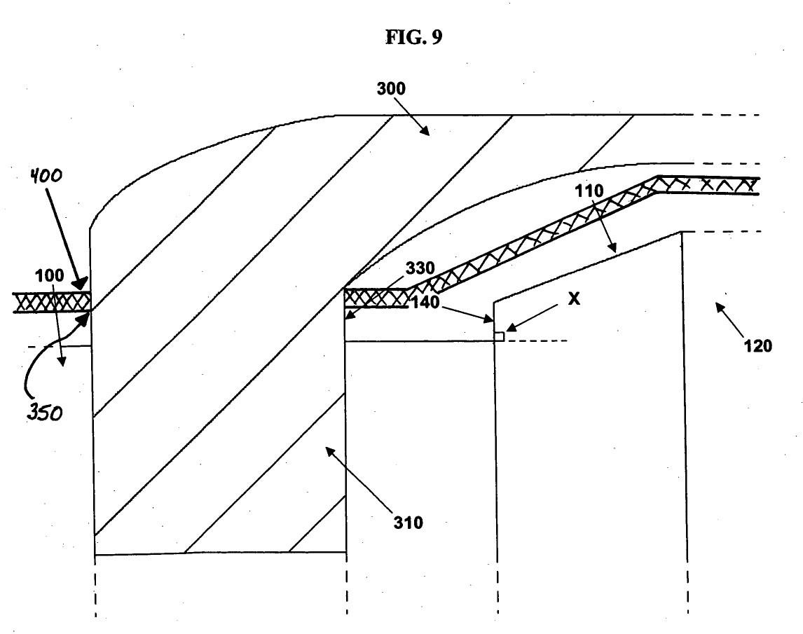

As illustrated by FIGS. 9-11, first stop surface 140 may be formed at a variety of angles. Specifically, first stop surface 140 may be formed at a 90 degree (90°) angle relative to the longitudinal axis of first pipe 100. Thus, angle X may be formed to be 90 degrees. Thus, when first clamping end 310 of clamping device 300 comes into contact with first stop surface 140, first clamp stop surface 330 axially abuts first stop surface 140. This axial abutment eliminates all radial forces and any possible wedge-like effect of sloping surface 110 on first clamping end 310. Thus, sloping surface 110 will not cause first clamping end 310 to break and will likewise prevent clamping device 300 from breaking and disengaging from first pipe 100. An angle X of 90 degrees is preferred because it is easily formed by machining or any other method.

Thus, when angle X is 90 degrees, first stop surface 140 sufficiently minimizes any radial, wedge-like forces acting against first clamping end 310 and prevents breakage of first clamping end 310 and disengagement of clamping device 300 when force F tending to move clamping device 300 towards second pipe 200 is applied. Also, first stop surface 140 prevents first clamping end 310 from moving along first stop surface 140 in an overlapping manner when an axial force F tending to move clamping device 300 towards second pipe 200 is applied. Moreover, first stop surface 140 prevents further movement of first clamping end 310 along the longitudinal axis of first pipe 100 toward first stop surface 140 after first clamping end 310 comes into contact with first stop surface 140.

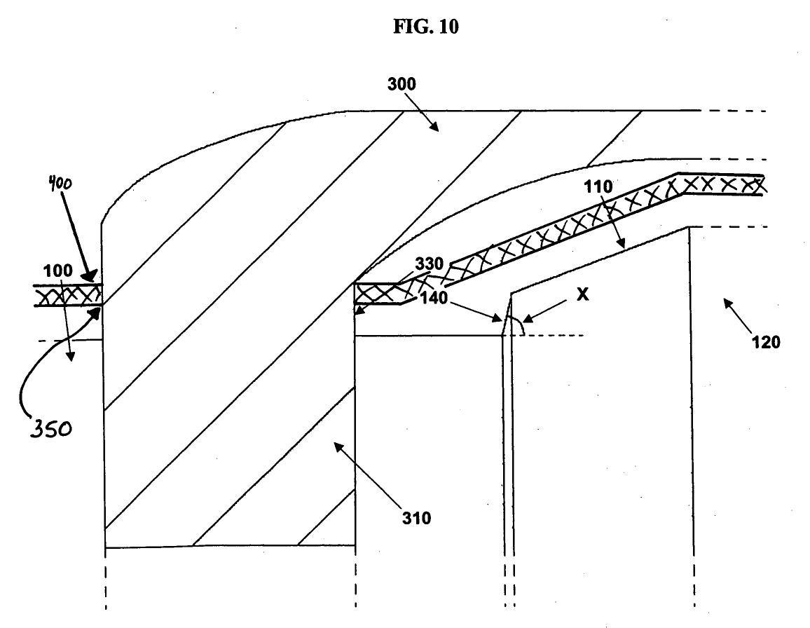

According to a second embodiment of the present invention and as shown in FIG. 10, first stop surface 140 may be formed at an angle less than 90 degrees relative to the longitudinal axis of first pipe 100. While any angle sufficient to prevent breakage of first clamping end 310 may be used, it is preferred, according to this embodiment, that angle X be between approximately 60 degrees (60°) and ninety degrees (90°). However, any angle less than 60 degrees may be used for first stop surface 140 if the angle is sufficient to prevent first clamping end 310 from structurally weakening, fracturing, or breaking under operational conditions. Thus, when first clamping end 310 of clamping device 300 comes into contact with first stop surface 140, first clamp stop surface 330 comes into contact with first stop surface 140. This abutment minimizes radial forces acting against first clamping end 310 and sufficiently minimizes the possibility of a wedge-like effect of sloping surface 110 on first clamping end 310. Thus, sloping surface 110 will not cause first clamping end 310 to break and will likewise prevent clamping device 300 from breaking and possibly disengaging from first pipe 100.

Thus, according to the second embodiment described above, first stop surface 140 sufficiently minimizes any radial, wedge-like forces acting against first clamping end 310 and reduces the chance of breakage of first clamping end 310 and disengagement of clamping device 300 when force F tending to move clamping device 300 towards second pipe 200 is applied. Also, first stop surface 140 minimizes the possibility of first clamping end 310 from moving along first stop surface 140 in an overlapping manner when an axial force F tending to move clamping device 300 towards second pipe 200 is applied. Moreover, first stop surface 140 minimizes the possibility of first clamping end 310 moving further along the longitudinal axis of first pipe 100 toward first stop surface 140 after first clamping end 310 comes into contact with first stop surface 140.

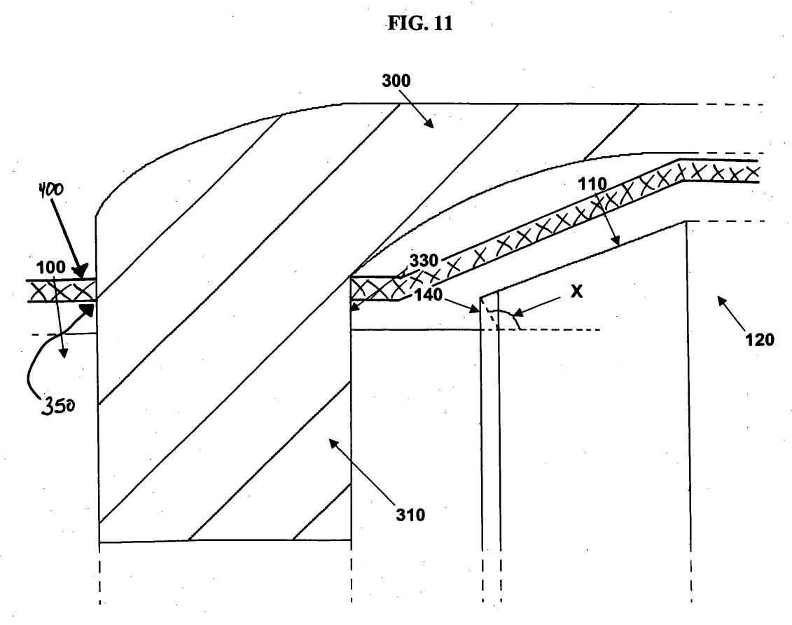

According to a third embodiment of the present invention and as shown in FIG. 11, first stop surface 140 may be formed at an angle greater than 90 degrees relative to the longitudinal axis of first pipe 100. Angle X may be any angle greater than 90 degrees (90°). Thus, when first clamping end 310 of clamping device 300 comes into contact with first stop surface 140, first clamp stop surface 330 axially abuts the upper corner of first stop surface 140 created by angle X exceeding 90 degrees. This abutment eliminates all radial forces and any possible wedge-like effect of sloping surface 710 on first clamping end 310. Thus, sloping surface 710 will minimize the possibility of first clamping end 310 breaking and will likewise prevent clamping device 300 from breaking and disengaging from first pipe 100 due to the wedge-like effect of sloping section 110.

According to another embodiment of the present invention, clamping device 300 may include both first clamping end 310 and second clamping end 320. Additionally, first stop surface 140 and second stop surface 240 can be formed on both first pipe 100 and second pipe 200, respectively. Thus, when a force F is applied to clamping device 300 causing clamping device 300 to slide along first pipe 100, first clamping end 310 comes into contact with first stop surface 140 as described above. Similarly, when a force F′ is applied to clamping device 300 causing clamping device 300 to slide in the opposite direction along second pipe 200, second clamping end 320 and second clamp stop surface 340 comes into contact with second stop surface 240. Second stop surface 240 may be of any design described above for first stop surface 140. Thus, the present invention minimizes the possibility of clamping device 300 becoming structurally weakened, fractured, or broken in response to longitudinal forces in either direction.

It will thus be seen that the objects set forth above, among those made apparent from the preceding description, are efficiently attained and, since certain changes may be made, in carrying out the above processes, in a described instrument, and in the construction set forth, without departing from the spirit and scope of the invention, it is intended that all matter contained in the above description shown in the accompanying drawings shall be interpreted as illustrative and not in a limiting sense.

It is also to be understood that the following claims are intended to cover all of the generic and specific features of the invention herein described, and all statements of the scope of the invention, which, as a matter of language, might be said to fall there between.

The claimed invention is:

1. A pipe coupling assembly for protecting control lines, the pipe coupling assembly comprising:
a first pipe including a first stop surface;
a second pipe longitudinally connected to said first pipe;
a clamping device connected to said first pipe and said second pipe, said clamping device including a first clamping end connected to said first pipe, said clamping device further including a control line receiving portion; and
a control line extending along the length of said first pipe and said second pipe positioned adjacent to said first pipe and said second pipe, said control line being positioned within said control line receiving portion of said clamping device,
wherein said first stop surface is positioned on said first pipe at a predetermined angle relative to a longitudinal axis of said first pipe to sufficiently minimize radial force acting against said first clamping end to prevent breakage of said clamping device when an axial force tending to move said clamping device towards said second pipe is applied.

2. The pipe coupling assembly of claim 1, wherein the angle of said first stop surface relative to said longitudinal axis of said first pipe is between approximately 60 degrees and 90 degrees.

3. The pipe coupling assembly of claim 1, wherein the angle of said first stop surface relative to said longitudinal axis of said first pipe is 90 degrees.

4. The pipe coupling assembly of claim 1, wherein the angle of said first stop surface relative to said longitudinal axis of said first pipe is greater than 90 degrees.

5. The pipe coupling assembly of claim 1, wherein said first clamping end includes a substantially transverse first clamp stop surface facing said first stop surface.

6. The pipe coupling assembly of claim 1, wherein said first stop surface extends circumferentially around said first pipe.

7. The pipe coupling assembly of claim 1, wherein said first pipe and said second pipe are of the integral joint tubing type.

8. The pipe coupling assembly of claim 1, wherein:
said second pipe includes a second stop surface; and
said clamping device includes a second clamping end connected to said second pipe;
wherein said second stop surface is positioned on said second pipe at a predetermined angle relative to said longitudinal axis of said second pipe to sufficiently minimize radial force acting against said second clamping end to prevent breakage of said clamping device when an axial force tending to move said second clamping device towards said first pipe is applied.

9. A pipe coupling assembly for protecting control lines, the pipe coupling assembly comprising:
a first pipe including a first stop surface;
a second pipe longitudinally connected to said first pipe;
a clamping device connected to said first pipe and said second pipe, said clamping device including a first clamping end connected to said first pipe, said clamping device further including a control line receiving portion; and
a control line extending along the length of said first pipe and said second pipe positioned adjacent to said first pipe and said second pipe, said control line being positioned within said control line receiving portion of said clamping device,
wherein said first stop surface is positioned on said first pipe at a predetermined angle relative to a longitudinal axis of said first pipe to prevent said first clamping end from moving along said first stop surface in an overlapping manner when an axial force tending to move said clamping device towards said second pipe is applied.

10. The pipe coupling assembly of claim 9, wherein the angle of said first stop surface relative to said longitudinal axis of said first pipe is between approximately 60 degrees and 90 degrees.

11. The pipe coupling assembly of claim 9, wherein the angle of said first stop surface relative to said longitudinal axis of said first pipe is 90 degrees.

12. The pipe coupling assembly of claim 9, wherein the angle of said first stop surface relative to said longitudinal axis of said first pipe is greater than 90 degrees.

13. The pipe coupling assembly of claim 9, wherein said first clamping end includes a substantially transverse first clamp stop surface facing said first stop surface.

14. The pipe coupling assembly of claim 9, wherein said first stop surface extends circumferentially around said first pipe.

15. The pipe coupling assembly of claim 9, wherein said first pipe and said second pipe are of the integral joint tubing type.

16. The pipe coupling assembly of claim 9, wherein:
said second pipe includes a second stop surface; and
said clamping device includes a second clamping end connected to said second pipe;
wherein said second stop surface is positioned on said second pipe at a predetermined angle relative to said longitudinal axis of said second pipe to prevent said second clamping end from moving along said second stop surface in an overlapping manner when an axial force tending to move said clamping device towards said first pipe is applied.

17. A pipe coupling assembly for protecting control lines, the pipe coupling assembly comprising:
a first pipe including a first stop surface;
a second pipe longitudinally connected to said first pipe;
a clamping device connected to said first pipe and said second pipe, said clamping device including a first clamping end connected to said first pipe, said clamping device further including a control line receiving portion; and
a control line extending along the length of said first pipe and said second pipe positioned adjacent to said first pipe and said second pipe, said control line being positioned within said control line receiving portion of said clamping device,
wherein said first stop surface is positioned on said first pipe at a predetermined angle relative to a longitudinal axis of said first pipe to prevent further movement of said first clamping end along said longitudinal axis toward said first stop surface after said first clamping end comes into contact with said first stop surface.

18. The pipe coupling assembly of claim 17, wherein the angle of said first stop surface relative to said longitudinal axis of said first pipe is between approximately 60 degrees and 90 degrees.

19. The pipe coupling assembly of claim 17, wherein the angle of said first stop surface relative to said longitudinal axis of said first pipe is 90 degrees.

20. The pipe coupling assembly of claim 17, wherein the angle of said first stop surface relative to said longitudinal axis of said first pipe is greater than 90 degrees.

21. The pipe coupling assembly of claim 17, wherein said first clamping end includes a substantially transverse first clamp stop surface facing said first stop surface.

22. The pipe coupling assembly of claim 17, wherein said first stop surface extends circumferentially around said first pipe.

23. The pipe coupling assembly of claim 17, wherein said first pipe and said second pipe are of the integral joint tubing type.

24. The pipe coupling assembly of claim 17, wherein:
said second pipe includes a second stop surface; and
said clamping device includes a second clamping end connected to said second pipe;
wherein said second stop surface is positioned on said second pipe at a predetermined angle relative to said longitudinal axis of said second pipe to prevent further movement of said second clamping end along said longitudinal axis toward said second stop surface after said second clamping end comes into contact with said second stop surface.

25. A method of assembling a pipe coupling assembly for protecting control lines, said method comprising:
forming a first stop surface on a first pipe;
longitudinally connecting said first pipe to a second pipe;
connecting a clamping device to said first pipe and said second pipe, said clamping device including a first clamping end connected to said first pipe, said clamping device further including a control line receiving portion; and
extending a control line along said first pipe and said second pipe, said control line being positioned with said control line receiving portion of said clamping device,
wherein said first stop surface is formed on said first pipe at a predetermined angle relative to a longitudinal axis of said first pipe to sufficiently minimize radial force acting against said first clamping end to prevent breakage of said clamping device when an axial force tending to move said clamping device towards said second pipe is applied.

26. The method of assembling a pipe coupling assembly for protecting control lines of claim 25, wherein the angle of said first stop surface formed on said first pipe relative to said longitudinal axis of said first pipe is between 60 degrees and 90 degrees.

27. The method of assembling a pipe coupling assembly for protecting control lines of claim 25, wherein the angle of said first stop surface formed on said first pipe relative to said longitudinal axis of said first pipe is 90 degrees.

28. The method of assembling a pipe coupling assembly for protecting control lines of claim 25, wherein the angle of said first stop surface formed on said first pipe relative to said longitudinal axis of said first pipe is greater than 90 degrees.

29. The method of assembling a pipe coupling assembly for protecting control lines of claim 25, wherein said first clamping end includes a substantially transverse first clamp stop surface facing said first stop surface.

30. The method of assembling a pipe coupling assembly for protecting control lines of claim 25, wherein said first stop surface extends circumferentially around said first pipe.

31. The method of assembling a pipe coupling assembly for protecting control lines of claim 25, wherein said first pipe and said second pipe are of the integral joint tubing type.

32. The method of assembling a pipe coupling assembly for protecting control lines of claim 25, further comprising:
forming a second stop surface on said second pipe;
wherein said first clamping end includes a second clamping end connected to said second pipe; and
wherein said second stop surface is formed on said second pipe at a predetermined angle relative to said longitudinal axis of said second pipe to sufficiently minimize radial force acting against said second clamping end to prevent breakage of said clamping device when an axial force tending to move said clamping device towards said first pipe is applied.

33. A method of assembling a pipe coupling assembly for protecting control lines, said method comprising:
forming a first stop surface on a first pipe;
longitudinally connecting said first pipe to a second pipe;
connecting a clamping device to said first pipe and said second pipe, said clamping device including a first clamping end connected to said first pipe, said clamping device further including a control line receiving portion; and
extending a control line along said first pipe and said second pipe, said control line being positioned with said control line receiving portion of said clamping device,
wherein said first stop surface is formed on said first pipe at a predetermined angle relative to a longitudinal axis of said first pipe to prevent said first clamping end from moving along said first stop surface in an overlapping manner when an axial force tending to move said clamping device towards said second pipe is applied.

34. The method of assembling a pipe coupling assembly for protecting control lines of claim 33, wherein the angle of said first stop surface formed on said first pipe relative to said longitudinal axis of said first pipe is between 60 degrees and 90 degrees.

35. The method of assembling a pipe coupling assembly for protecting control lines of claim 33, wherein the angle of said first stop surface formed on said first pipe relative to said longitudinal axis of said first pipe is 90 degrees.

36. The method of assembling a pipe coupling assembly for protecting control lines of claim 33, wherein the angle of said first stop surface formed on said first pipe relative to said longitudinal axis of said first pipe is greater than 90 degrees.

37. The method of assembling a pipe coupling assembly for protecting control lines of claim 33, wherein said first clamping end includes a substantially transverse first clamp stop surface facing said first stop surface.

38. The method of assembling a pipe coupling assembly for protecting control lines of claim 33, wherein said first stop surface extends circumferentially around said first pipe.

39. The method of assembling a pipe coupling assembly for protecting control lines of claim 33, wherein said first pipe and said second pipe are of the integral joint tubing type.

40. The method of assembling a pipe coupling assembly for protecting control lines of claim 33, further comprising:
forming a second stop surface on said second pipe;
wherein said first clamping end includes a second clamping end connected to said second pipe; and
wherein said second stop surface is formed on said second pipe at a predetermined angle relative to said longitudinal axis of said second pipe to prevent said second clamping end from moving along said second stop surface in an overlapping manner when an axial force tending to move said clamping device towards said second pipe is applied.

41. A method of assembling a pipe coupling assembly for protecting control lines, said method comprising:
forming a first stop surface on a first pipe;
longitudinally connecting said first pipe to a second pipe;
connecting a clamping device to said first pipe and said second pipe, said clamping device including a first clamping end connected to said first pipe, said clamping device further including a control line receiving portion; and
extending a control line along said first pipe and said second pipe, said control line being positioned with said control line receiving portion of said clamping device,
wherein said first stop surface is formed on said first pipe at a predetermined angle relative to a longitudinal axis of said first pipe to prevent further movement of said first clamping end along said longitudinal axis toward said first stop surface after said first clamping end comes into contact with said first stop surface.

42. The method of assembling a pipe coupling assembly for protecting control lines of claim 41, wherein the angle of said first stop surface formed on said first pipe relative to said longitudinal axis of said first pipe is between 60 degrees and 90 degrees.

43. The method of assembling a pipe coupling assembly for protecting control lines of claim 41, wherein the angle of said first stop surface formed on said first pipe relative to said longitudinal axis of said first pipe is 90 degrees.

44. The method of assembling a pipe coupling assembly for protecting control lines of claim 41, wherein the angle of said first stop surface formed on said first pipe relative to said longitudinal axis of said first pipe is greater than 90 degrees.

45. The method of assembling a pipe coupling assembly for protecting control lines of claim 41, wherein said first clamping end includes a substantially transverse first clamp stop surface facing said first stop surface.

46. The method of assembling a pipe coupling assembly for protecting control lines of claim 41, wherein said first stop surface extends circumferentially around said first pipe.

47. The method of assembling a pipe coupling assembly for protecting control lines of claim 41, wherein said first pipe and said second pipe are of the integral joint tubing type.

48. The method of assembling a pipe coupling assembly for protecting control lines of claim 41, further comprising:
forming a second stop surface on said second pipe;
wherein said first clamping end includes a second clamping end connected to said second pipe; and
wherein said second stop surface is formed on said second pipe at a predetermined angle relative to said longitudinal axis of said second pipe to prevent further movement of said second clamping end along said longitudinal axis toward said second stop surface after said second clamping end comes into contact with said second stop surface.

49. A pipe coupling assembly comprising:
a first pipe including a first stop surface;
a second pipe longitudinally connected to said first pipe; and
a clamping device connected to said first pipe and said second pipe, said clamping device including a first clamping end connected to said first pipe,
wherein said first stop surface is positioned on said first pipe at a predetermined angle relative to a longitudinal axis of said first pipe to sufficiently minimize radial force acting against said first clamping end to prevent breakage of said clamping device when an axial force tending to move said clamping device towards said second pipe is applied.

50. The pipe coupling assembly of claim 49 further comprising a control line extending along the length of said first pipe and said second pipe positioned adjacent to said first pipe and said second pipe.

51. The pipe coupling assembly of claim 50 wherein said clamping device includes a control line receiving portion adapted to receive said control line.

52. The pipe coupling assembly of claim 49, wherein the angle of said first stop surface relative to said longitudinal axis of said first pipe is between approximately 60 degrees and 90 degrees.

53. The pipe coupling assembly of claim 49, wherein the angle of said first stop surface relative to said longitudinal axis of said first pipe is 90 degrees.

54. The pipe coupling assembly of claim 49, wherein the angle of said first stop surface relative to said longitudinal axis of said first pipe is greater than 90 degrees.

55. The pipe coupling assembly of claim 49, wherein said first clamping end includes a substantially transverse first clamp stop surface facing said first stop surface.

56. The pipe coupling assembly of claim 49, wherein said first stop surface extends circumferentially around said first pipe.

57. The pipe coupling assembly of claim 49, wherein said first pipe and said second pipe are of the integral joint tubing type.

58. The pipe coupling assembly of claim 49, wherein:
said second pipe includes a second stop surface; and
said clamping device includes a second clamping end connected to said second pipe;
wherein said second stop surface is positioned on said second pipe at a predetermined angle relative to said longitudinal axis of said second pipe to sufficiently minimize radial force acting against said second clamping end to prevent breakage of said clamping device when an axial force tending to move said second clamping device towards said first pipe is applied.
